(19) United States
(12) Patent Application Publication
(10) Pub. No.: US 2010/0046796 A1
(43) Pub. Date: Feb. 25, 2010

(54) METHOD OF RECOGNIZING A MOTION PATTERN OF AN OBJECT

(75) Inventor: Olivier Pietquin, Aiseau-Presles (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/993,496

(22) PCT Filed: Jun. 23, 2006
(86) PCT No.: PCT/IB2006/052052

§ 371 Date: Dec. 21, 2007

(30) Foreign Application Priority Data
Jun. 30, 2005 (EP) 05105941.8

(51) Int. Cl. G06K 9/00

(52) U.S. Cl. 382/103

(57) ABSTRACT

A method and a motion recognition system is disclosed for recognizing a motion pattern of at least one object by means of determining relative motion blur variations around the at least on object in an image or a sequence of images. Motion blur parameters are extracted from the motion blur in the images, and based thereon the motion blur variations are determined by means of determining variations between the motion blur parameters.

The present invention relates to a method and a motion recognizer for recognizing a motion pattern of at least one object by means of determining relative motion blur variations around said at least one object in an image or a sequence of images of said at least one object.

It is well known that in an image of an object which is taken by a stationary camera there can be a motion blur surrounding the object in the image if the object was moving when the image was taken. As an example, if the object is a person which is walking along a horizontal axis, the blur surrounding the person will occur on both the right and the left side of the person. Therefore, one cannot say whether the person is walking from left to right, or from right to left along the axis.

U.S. Pat. No. 6,766,036 discloses a method for controlling a functional device of a vehicle, wherein a user interacts with the vehicle via various position and orientation related functions, e.g. by moving his finger in an up/down motion by using a light source, wherein the different positions of the light source are detected by a camera. Based on the detection a desired control function for the device is determined. This invention discloses using intensity variation to identify and/or track object target datums, where bright targets such as LED or retroreflectors are used. If a movement takes place of the target image then a blur will, in a specific direction, be identifiable, wherein the blur direction indicates the axial motion as well.

The problem with this disclosure is how user unfriendly it is, since the requirement of this invention is that the user must wear said light source which is bright and easily recognizable by said camera. Furthermore, in U.S. Pat. No. 6,766,036 the blur is used in a very restricted way since only the direction parameter is extracted from the blur in this reference.

It is an object of the present invention to solve the above mentioned problems by means of expanding the use of information provided in motion blur and implementing said use in recognizing a motion pattern of an object.

According to one aspect, the present invention relates to a method of recognizing a motion pattern of at least one object by means of determining relative motion blur variations around said at least one object in an image or a sequence of images of said at least one object, the method comprising the steps of:
extracting motion blur parameters from the motion blur in said image or said sequence of images, and
determining variations between said motion blur parameters.

Therefore, a very easy and user friendly method is provided for recognizing a motion pattern of an object based on variations of the motion blur. The object can be a person, a hand of a person, fingers etc. Said method can be implemented in gesture recognition where a user can interact with a gesture recognition system, e.g. an anthropomorphic system, simply by pointing or using any kind of sign language, which can e.g. be preferred in an environment which is very noisy. Another example of implementing this method is in sign language recognition, by using a computer and e.g. a webcam or any kind of camera, wherein position sensors as used in prior art methods are no longer needed. This makes the present method much cheaper and easier to implement than other prior art methods.

In an embodiment, said blur parameters comprise the extent of the detected motion blur wherein the extent is used as an indicator for the speed of the object. Therefore, an indicator for the relative speed of the object is obtained, where a low extent indicates a low speed, and larger extent indicates a larger speed.

In an embodiment, the time evolution of said extent of the detected motion blur for said object in said sequence of images is used for recognizing the motion pattern of said object. Thereby, by detecting the extents of the detected motion blur for a number of images taken at different time values, it can be determined from said images whether the object is accelerating, or moving with constant speed, i.e. a one dimensional kinematics of the object is obtained.

In an embodiment, the relative extent of the detected motion blur between two or more objects within the same image is used for recognizing the relative speeds of said objects within said image. Thereby, it can be determined which of e.g. two or more objects within the same image is moving fastest, which one is moving second fastest etc. based on said relative extent of the detected motion blur.

In an embodiment, said motion blur parameters comprise the direction of the blur wherein by determining the variations in said direction the trajectory of the object is obtained. Thereby, the trajectory of e.g. a person in a room can be followed which e.g. enhances said gesture recognition significantly. Furthermore, by combining said direction and said extent parameters a three dimensional kinematics of the object is obtained.

In one embodiment, said image or said sequence of images comprises stationary image(s) captured by a stationary camera. In another embodiment, said sequence of images comprise images captured by a moving camera, wherein the motion blur around said at least one object in said images due to said movement is subtracted from the blur. The former acquisition system could be a webcam camera, and the second acquisition system could be a surveillance camera, where the background blur is subtracted from the blur in said images.

In a further aspect, the present invention relates to a computer readable medium having stored therein instructions for causing a processing unit to execute said method.

According to another aspect, the present invention relates to a motion recognizer recognizing a motion pattern of at least one object by means of determining relative motion blur variations around said at least one object in an image or a sequence of images of said at least one object, comprising:
a processor for extracting motion blur parameters from the motion blur in said image or said sequence of images and,
a processor for determining variations between said motion blur parameters.

These and other aspects of the invention will be apparent from and elucidated with reference to the embodiment(s) described hereinafter.

In the following preferred embodiments of the invention will be described referring to the figures, where:

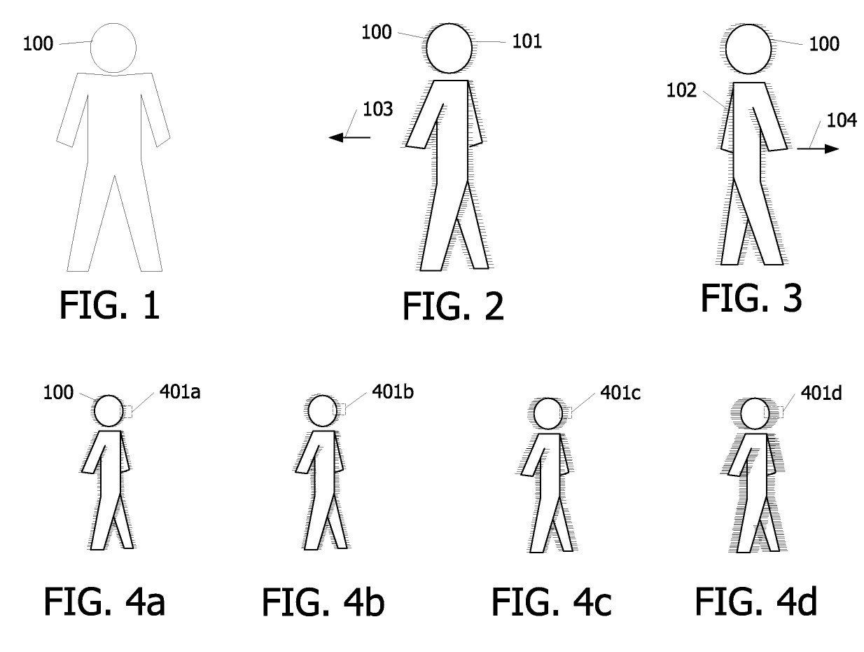

FIGS. 1-3 show three still images of a person in three different moving conditions,

FIG. 4(a)-(d) illustrates one example of the present invention showing time variations of a width of a local motion blur between successive images is processed for recognizing the motion pattern of the object,

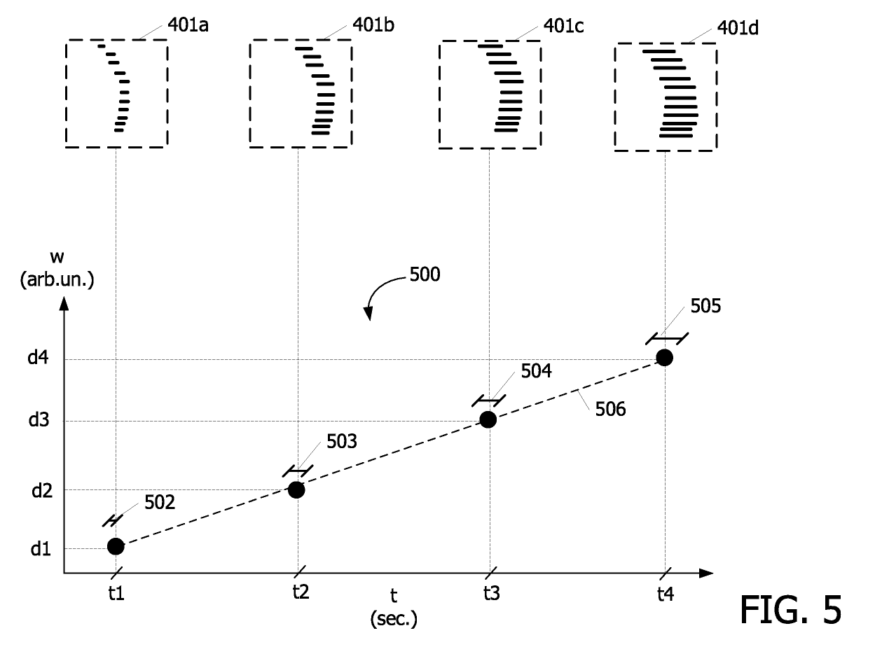

FIG. 5 shows an enlarged view of the blur in areas in FIG. 4(a)-(d),

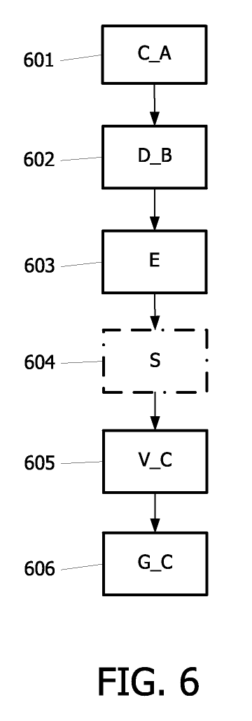

FIG. 6 shows a method according to the present invention for recognizing a motion pattern of an object based on at least one image of the object, and

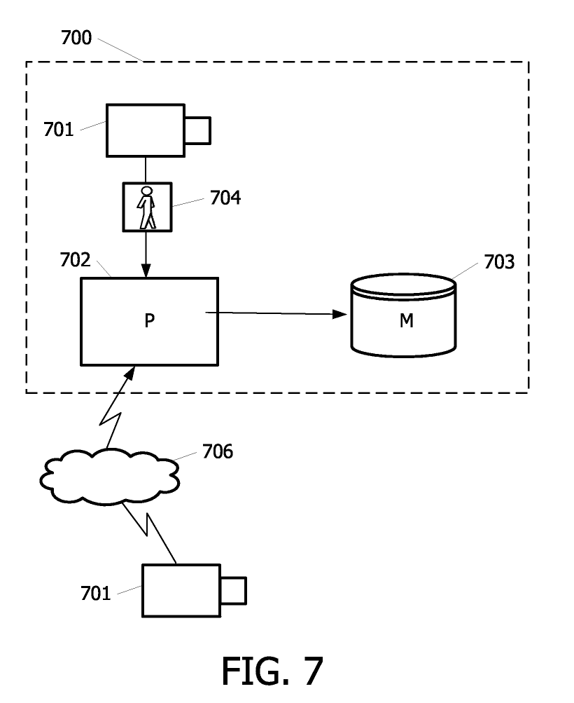

FIG. 7 shows a motion recognizer according to the present invention for recognizing a motion pattern of an object.

FIGS. 1-3 show three still images of a person 100 in three different moving conditions, where the images are captured by a camera, e.g. a digital camera, webcam camera, surveillance camera and the like. In FIG. 1 the person 100 is standing still, in FIG. 2 the person is moving from right to left as indicated by arrow 103, and in FIG. 3 the person is moving from left to right as indicated by arrow 104. According to the present invention a blur 101, 102 is used as an information source for recognizing the motion pattern of an object, i.e. in this case to recognize the motion pattern of the person 100. Therefore, instead of considering the blur as noise which should be eliminated, the blur is used for extracting blur motion parameters, and these are then used to recognize the motion pattern of the object in relation to said camera. Here, it will be assumed that the camera is in a fixed position, so that there will be no background blur in the images, which would otherwise be the case if the camera would be moving while capturing the images. In cases where the camera would be moving the background blur would, due to the movement of the camera, have to be subtracted when processing the images.

The fact that in FIG. 1 no blur is detected indicates that the person is standing still. As shown in FIGS. 2 and 3, the motion blur 101, 102 indicates that the person 100 is moving either from left to right, or right to left. The actual direction given by arrows 103, 104 cannot be determined since the blur 101, 102 occurs on both sides of the person 100.

In one embodiment, the motion pattern of the person 100 (the object) comprises the trajectory of the person 100, wherein the trajectory is determined by determining how the position of the motion blur 101, 102 changes as a function of time for a sequence of images of the person 100.

In another embodiment, the motion pattern of the person 100 (the object) comprises determining whether the person 100 is moving with constant speed or is accelerating. This can be determined based on changes in the extent of the motion blur as a function of time for a sequence of images of the person 100. As shown in FIGS. 2 and 3, since the extent between the two images is substantially the same, the person 100 in the two figures is moving with substantially the same speed. By combining this motion pattern with said trajectory of the person 100 a detailed kinematics of the person 100 (object) is obtainable.

In yet another embodiment of the present invention, the extent of the motion blur is used to determine the absolute speed of the object. In that way, by considering only one image of e.g. one object, the extent of the motion blur is used to determine the absolute value of the speed of the object. It is necessary to perform a calibration which links the extent of the blur “ext” with the speed of the object, V(ext), where e.g. V(ext)˜ext. As an example the present invention can be implemented for a speed detector. Here it is assumed that the speed of the object is proportional to the extent “ext” of the motion blur. In this simple example, the calibration parameter is a constant, i.e. V(ext)=const*ext. The object could e.g. be a car and the camera is a speed detecting camera. In the simplest embodiment it is assumed that the distance between the camera and the object is always fixed, e.g. the camera is situated above or sidewise to the street. The calibration could of course further include the distance between the object and the camera.

FIG. 4(a)-(d) illustrate one example of the present invention showing time variations of an extent of a local motion blur between four successive images, wherein these variations are processed and used for recognizing whether the object is moving with constant speed or is accelerating. As shown here, the object is the person 100 shown in FIG. 1, and the motion pattern of the person is recognized based on a sequence of images (a)-(d) detected by said camera for four different time values, t1-t4 where t1<t2<t3<t4. The motion blur parameters relating to the extent of the motion blur in 401a-401d are then extracted from said images. These are then used for recognizing the motion pattern in relation to the position of said camera. The increase of the extent of the local blur 401a-401d indicates that the person is accelerating with positive acceleration.

FIG. 4(a)-(d) can also be considered as a single image of four different persons. By determining the relative extent between the four persons, the relative speed between the four persons can be determined. Accordingly, since the extent of the blur for person (a) is smallest, second smallest for person (b), second largest for person (c) and largest for person (d), it follows that the speed of person (a) is smallest, is second smallest for person (b), second largest for person (c), and largest for person (d), i.e. V(a)<V(b)<V(c)<V(d), where V are the speeds of the objects. In the absence of speed calibration (where the speed is measured and associated to the motion blur extent for a fixed distance), one cannot predict how fast V(a, b, c, d) is moving. Only, the relative speed differences can be determined. However, by making said calibration, these speeds could also be obtained.

FIG. 5 shows an enlarged view of the blur in areas 401a-401d in FIG. 4, where we assume that the four persons are the same person. The extent d1-d4 502-505 of the local blur 401a-401d is plotted on the vertical axis, in the graph 500 for said four evenly distributed time values t1-t4. As shown here, at time t1 the extent d1 of the blur, which is given in arbitrary units, is smallest at t1 but increases steadily and becomes largest d4 at time value t4. The increase of the extent with time states that the motion pattern of the person 100, which is moving from left to right or from right to left, is an accelerated motion. Also, due to the straight line 506, the accelerated motion is a uniform acceleration.

As mentioned previously, the trajectory of the person 100 could additionally be used by additionally determining how the motion blur parameter indicating the position of the motion blur changes with time for said sequence of images in FIG. 4(a)-(d).

One way to implement the present invention is to associate gestures, for e.g. monitoring whether the person 102 is coming or leaving, or for some basic commands commonly occurring during a dialogue system like stopping the interaction with the anthropomorphic system, waiting, going back, continuing, asking for help etc. This would allow avoiding a speech interaction with the system when the environment is too noisy for example. Real multimodal interactions where the person 102 provides complementary information both by a speech and a gesture would also be possible. If for instance the person 102 wants the image source to move in a given direction s/he could say “please watch this way” and show the direction by moving her/his arm in the direction.

Another way of implementing the present invention is in sign language interpretations by using a computer and a webcam instead of position sensors. A user with a common personal computer could therefore transcribe sign language into text standing in front of it or use text-to-speech software to convert the text into audible speech.

FIG. 6 shows a method according to the present invention for recognizing a motion pattern of an object based on at least one image of the object. Initially, a number of still images are captured (C_A) in step 601 by e.g. a digital video camera. The blur is then detected (D_B) in step 602 from the images and, based on the detection, motion blur parameters are extracted (E) in step 603. The detection of the motion blur can e.g. be done by measuring the continuity of the edges in the image by computing the Lipschitz coefficients, wherein if the edge is clear it corresponds to a strong discontinuity in the direction of the gradient of the image, and if it is blurred it corresponds to a smooth discontinuity. Several methods exist to extract motion blur parameters, such as disclosed by Mallet et. al., which is hereby enclosed as a reference, “S. Mallet and W. L. Hwang, Singularity detection and processing with wavelets, IEEE Transactions on Information Theory, vol. 32, no. 2, March 1992”.

In the case where the camera is moving while capturing the images, the “background” blur caused due to the motion of the camera must be subtracted/cancelled from the images (S) in step 604.

After extracting the motion blur parameters from the detected blur, variation computation is performed for the motion between successive images (V_C) in step 605. This can e.g. comprise computing whether the position of the motion blur parameters has changed between two subsequent images, whether the extent of the blur (e.g. within a certain area of the object) has changed to determine whether the object is moving with constant speed, or is accelerating. These variations then serve as features, or input parameters for e.g. gesture classification/recognition (G_C) in step 606 algorithm.

As an example, if a user indicates no with his/her head (by shaking the head), the blur parameters will vary around the user's face as follows:
first a clear image of the face (no blur)
then a series of horizontal motion blur will be detected with different widths (because the head is accelerated from the center to one side, then slowed and even stopped at each side and accelerated again from one side to the other several times)
finally a new clear image of the face.

FIG. 7 shows a motion recognizer 700 according to the present invention for recognizing a motion pattern of an object, wherein the recognizer 700 comprises a camera 701, a processor (P) 702 adapted to extract blur parameters from an image 704 of said object, and a memory (M) 703 having stored therein a recognition software. The camera (C) 701 is used for providing images, preferably digital images 704 of an object and can be integrated into motion recognizer 700, or be situated externally and be interconnected to the motion recognizer 700 via wireless communication network 706. This could e.g. be the case where the image source is a surveillance camera and the motion recognizer is situated at other locations, e.g. at a central server, police station etc. The memory 703 can have a pre-stored set of rules which, in conjunction with said motion blur parameters, recognize the motion pattern of the object.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method of recognizing a motion pattern of at least one object (100) by means of determining relative motion blur (101, 102, 401a-401d) variations around said at least one object (100) in an image or a sequence of images of said at least one object (100), the method comprising the steps of:
extracting motion blur parameters from the motion blur (101, 102) in said image or said sequence of images, and
determining variations between said motion blur parameters.

2. A method according to claim 1, wherein said blur parameters comprise the extent (502-505) of the detected motion blur (101, 102, 401a-401d) wherein the extent is used as an indicator for the speed of the object (100).

3. A method according to claim 1, wherein the time evolution of said extent of the detected motion blur (101, 102, 401a-401d) for said object in said sequence of images is used for recognizing the motion pattern of said object (100).

4. A method according to claim 1, wherein the relative extent of the detected motion blur (101, 102, 401a-401d) between two or more objects within the same image is used for recognizing the relative speeds of said objects within said image.

5. A method according to claim 1, wherein said motion blur (101, 102, 401a-401d) parameters comprise the direction of the blur, wherein by determining the variations in said direction the trajectory of the object (100) is obtained.

6. A method according to claim 1, wherein said image or said sequence of images comprises stationary image(s) captured by a stationary camera (701).

7. A method according to claim 1, wherein said image or said sequence of images comprises images captured by a moving camera (701), wherein the motion blur around said at least one object in said image or said images due to said movement is subtracted from the blur (101, 102, 401a-401d).

8. A computer-readable medium having stored therein instructions for causing a processing unit to execute a method according to claim 1.

9. A motion recognizer (700) recognizing a motion pattern of at least one object (100) by means of determining relative motion blur (101, 102, 401a-401d) variations around said at least one object (100) in an image or a sequence of images of said at least one object (100), comprising:
a processor (702) for extracting motion blur parameters from the motion blur (101, 102, 401a-401d) in said image or said sequence of images and,
a processor (702) for determining variations between said motion blur parameters.
